(19) United States
(12) Patent Application Publication
(10) Pub. No.: US 2024/0212180 A1
(43) Pub. Date: Jun. 27, 2024

(54) IMAGE PROCESSOR AND IMAGE PROCESSING SYSTEM INCLUDING THE IMAGE PROCESSOR

(71) Applicant: SK hynix Inc., Gyeonggi-do (KR)

(72) Inventor: Ji Hee HAN, Gyeonggi-do (KR)

(21) Appl. No.: 18/214,525

(22) Filed: Jun. 27, 2023

(30) Foreign Application Priority Data
Dec. 23, 2022 (KR) 10-2022-0183281

(51) Int. Cl. G06T 7/50; G06V 10/25; G06V 10/60

(52) U.S. Cl. CPC G06T 7/50; G06V 10/25; G06V 10/60; G06T 2207/20228

(57) ABSTRACT

Disclosed is an image processor and an image processing system including the image processor, and the image processing system may include an image sensor including a plurality of pixel areas, and configured to generate pixel values from the plurality of pixel areas, and an image processor configured to, based on the pixel values and a calibration map, calibrate a disparity value for each pixel area, and generate a depth map.

### CROSS-REFERENCE TO RELATED APPLICATION(S)

This application claims priority under 35 U.S.C. § 119 to Korean Patent Application No. 10-2022-0183281, filed on Dec. 23, 2022, the disclosure of which is incorporated herein by reference in its entirety.

### BACKGROUND

### 1. Field

Various embodiments of the present disclosure relate to a semiconductor design technique, and more particularly, to an image processor for generating a depth map on the basis of pixel values, and an image processing system including the image processor.

### 2. Description of the Related Art

An image sensor is a device for capturing images using the property of a semiconductor which reacts to light. Image sensors may be classified into a charge-coupled device (CCD) image sensor and a complementary metal-oxide semiconductor (CMOS) image sensor. Recently, the CMOS image sensor is widely used because the CMOS image sensor can allow both analog and digital control circuits to be directly implemented on a single integrated circuit (IC).

An image processor may generate a depth map on the basis of pixel values generated from the image sensor. Various side effects occur according to applications used by the image processor to extract the depth map. When the image processor uses a Bokeh application, there is an issue in that a blurring phenomenon is not evenly reflected in a background part (or peripheral part) of an image.

### SUMMARY

Various embodiments of the present disclosure are directed to an image processor capable of evenly reflecting a blurring phenomenon in a background part of an image by calibrating a depth map, and an image processing system including the image processor.

In addition, various embodiments of the present disclosure are directed to an image processor capable of properly calibrating the depth map according to illuminance, and an image processing system including the image processor.

In accordance with an embodiment of the present disclosure, an image processor may include: a calibration map generator configured to generate a calibration map representing characteristics of pixel values corresponding to a depth map; and a calibrator configured to calibrate a disparity value for each pixel area based on the pixel values and the calibration map.

In accordance with an embodiment of the present disclosure, an image processing system may include: an image sensor including a plurality of pixel areas, and configured to generate pixel values from the plurality of pixel areas; and an image processor configured to, based on the pixel values and a calibration map, calibrate a disparity value for each pixel area, and generate a depth map.

In accordance with an embodiment of the present disclosure, an image processing method may include: generating, based on pixel values generated from a plurality of pixel areas of an image sensor, a plurality of disparity values corresponding to the plurality of pixel areas; generating a calibration map representing characteristics of the pixel values; mapping, based on a plurality of disparity values and the calibration map, a disparity value of a target pixel area among the plurality of pixel areas to a disparity value of a reference pixel area among the plurality of pixel areas, generating a depth map based on the disparity values.

In accordance with an embodiment of the present disclosure, an image processor may include: a calibrator suitable for generating a depth map on the basis of disparity values and a calibration map; and a calibration map generator suitable for sampling at least two first reference calibration maps according to illuminance, generating at least one second reference calibration map by interpolating the first reference calibration maps, and providing the calibrator with a reference calibration map corresponding to current illuminance between the first and second reference calibration maps as the calibration map.

The calibration map may include a first characteristic map corresponding to slopes of linear functions representing characteristics of a plurality of pixel areas and a second characteristic map corresponding to intercepts of the linear functions.

Each of the linear functions may represent a relationship between a disparity value and an inverse distance value which are generated for each pixel area.

The calibration map and the depth map may have the same resolution.

The calibrator may calibrate the disparity value for each pixel area on the basis of the disparity values and the calibration map.

The calibrator may map a disparity value of a target pixel area among a plurality of pixel areas to a disparity value of a reference pixel area among the plurality of pixel areas.

The reference pixel area may include a pixel area disposed in the center of a pixel array among the plurality of pixel areas included in the pixel array.

### BRIEF DESCRIPTION OF THE DRAWINGS

FIG. 1 is a block diagram illustrating an image processing system in accordance with an embodiment of the present disclosure.

FIG. 2 is a detailed block diagram of an image sensor illustrated in FIG. 1.

FIG. 3 is a detailed block diagram of an image processor illustrated in FIG. 1.

FIGS. 4 to 6 are diagrams for describing an operation of the image processing system in accordance with an embodiment of the present disclosure.

### DETAILED DESCRIPTION

Various embodiments of the present disclosure are described below with reference to the accompanying drawings, in order to describe in detail the present disclosure so that those with ordinary skill in art to which the present disclosure pertains may easily carry out the technical spirit of the present disclosure.

It will be understood that when an element is referred to as being “connected to” or “coupled to” another element, the element may be directly connected to or coupled to the another element, or electrically connected to or coupled to the another element with one or more elements interposed therebetween. In addition, it will also be understood that the terms “comprises,” “comprising,” “includes,” and “including” when used in this specification do not preclude the presence of one or more other elements, but may further include or have the one or more other elements, unless otherwise mentioned. In the description throughout the specification, some components are described in singular forms, but the present disclosure is not limited thereto, and it will be understood that the components may be formed in plural.

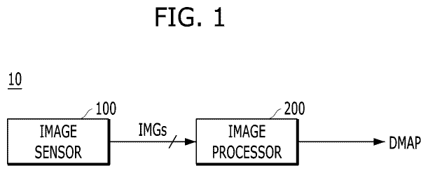

FIG. 1 is a block diagram illustrating an image processing system 10 in accordance with an embodiment of the present disclosure.

Referring to FIG. 1, the image processing system 10 may include an image sensor 100 and an image processor 200.

The image sensor 100 may generate pixel values IMGs. In a test mode, the image sensor 100 may capture a scene having the same texture pattern (e.g., flat pattern) for each distance M, and generate the pixel values IMGs corresponding to a plurality of captured images. In a normal mode, the image sensor 100 may capture a current scene, and generate the pixel values IMGs corresponding to the captured image.

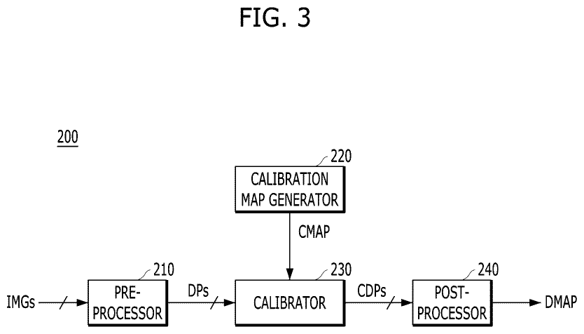

The image processor 200 may generate the depth map DMAP on the basis of the pixel values IMGs. In the test mode, the image processor 200 may generate a calibration map CMAP (see FIG. 3) on the basis of the pixel values IMGs corresponding to the plurality of images. In the normal mode, the image processor 200 may generate the depth map DMAP on the basis of the pixel values IMGs and the calibration map CMAP.

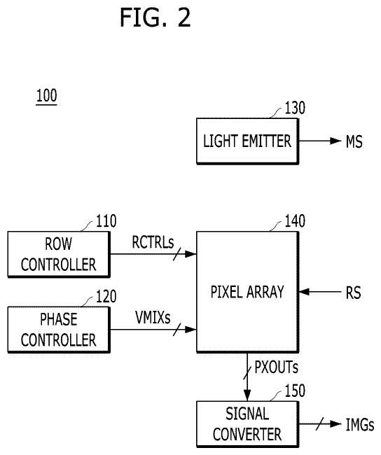

FIG. 2 is a detailed block diagram illustrating the image sensor 100 illustrated in FIG. 1.

Referring to FIG. 2, the image sensor 100 may generate the pixel values IMGs indicating its depth from a subject (not illustrated) using a time of flight (TOF) method. For example, the image sensor 100 may generate the pixel values IMGs suitable for calculating a phase difference between emitted light MS that is emitted to the subject and incident light RS that is reflected from the subject. In an embodiment, the image sensor 100 may include a row controller 110, a phase controller 120, a light emitter 130, a pixel array 140 and a signal converter 150.

The row controller 110 may generate a plurality of row control signals RCTRLs for controlling the pixel array 140 for each row. The phase controller 120 may generate a plurality of clock

signals VMIXs having different phases. For example, the plurality of clock signals VMIXs may include first to fourth clock signals. The first and second clock signals may have a phase difference of 90 degrees therebetween, the second and third clock signals may have a phase difference of 90 degrees therebetween, and the third and fourth clock signals may have a phase difference of 90 degrees therebetween. For another example, the plurality of clock signals VMIXs may include first and second clock signals. The first and second clock signals may have a phase difference of 180 degrees therebetween.

The light emitter 130 may output the emitted light MS to the subject (not illustrated).

The pixel array 140 may generate a plurality of pixel signals PXOUTs on the basis of the incident light RS, the plurality of row control signals RCTRLs and the plurality of clock signals VMIXs. The pixel array 140 may include a plurality of pixel groups. Each of the plurality of pixel groups may include two or more pixels. The two or more pixels may be arranged in a 2x1 structure, a 2x2 structure or the like, and share one micro-lens. For example, when each of the plurality of pixel groups includes first to fourth pixels arranged in a 2x2 structure, the first to fourth pixels may receive the first to fourth clock signals having a phase difference of 90 degrees therebetween.

The signal converter 150 may convert the plurality of pixel signals PXOUTs which are analog signals, into the pixel values IMGs which are digital signals.

FIG. 3 is a detailed block diagram illustrating the image processor 200 illustrated in FIG. 1.

Referring to FIG. 3, the image processor 200 may include a pre-processor 210, a calibration map generator 220, a calibrator 230 and a post-processor 240.

The pre-processor 210 may generate a plurality of disparity values DPs corresponding to a plurality of pixel areas, on the basis of the pixel values IMGs. Each of the plurality of pixel areas may include at least one of the plurality of pixel groups. For example, each of the plurality of pixel areas may include one of the plurality of pixel groups. For another example, each of the plurality of pixel areas may include two or more adjacent pixel groups among the plurality of pixel groups. Herein, adjacent pixel areas among the plurality of pixel areas may include at least one pixel group among the two or more pixel groups in common. Each of the plurality of disparity values DPs may correspond to the phase difference between the emitted light MS and the incident light RS for each pixel area. For example, when each of the plurality of pixel areas includes the one pixel group, each of the plurality of disparity values DPs may be one disparity value corresponding to the one pixel group. For another example, when each of the plurality of pixel areas includes the two or more pixel groups, each of the plurality of disparity values DPs may be an average value of two or more disparity values corresponding to the two or more pixel groups.

The calibration map generator 220 may generate the calibration map CMAP representing characteristics of the pixel values IMGs. For example, the calibration map CMAP may include a first characteristic map corresponding to slopes of linear functions representing characteristics of the plurality of pixel areas and a second characteristic map corresponding to intercepts, i.e., y-intercepts, of the linear functions. Each of the linear functions may represent a relationship between a disparity value and an inverse distance value, which are generated for each pixel area. The inverse distance value may refer to a reciprocal number of the distance M (i.e., 1/M). The linear functions may be estimated through a least square method. The calibration map CMAP and the depth map DMAP may have the same resolution.

For example, in the test mode, the calibration map generator 220 may generate, according to illuminance, at least two reference calibration maps on the basis of the pixel values IMGs inputted according to the illuminance. In the normal mode, the calibration map generator 220 may use, as the calibration map CMAP, a reference calibration map corresponding to current illuminance, among the reference calibration maps.

For another example, in the test mode, the calibration map generator 220 may sample, according to the illuminance, at least two first reference calibration maps on the basis of the pixel values IMGs inputted according to the illuminance, and generate at least one second reference calibration map by interpolating the first reference calibration maps. In the normal mode, the calibration map generator 220 may use, as the calibration map CMAP, the reference calibration map corresponding to the current illuminance, between the first and second reference calibration maps.

The calibrator 230 may calibrate the plurality of disparity values DPs, and generate a plurality of calibrated disparity values CDPs on the basis of the plurality of disparity values DPs and the calibration map CMAP. For example, in the normal mode, the calibrator 230 may map a disparity value of a target pixel area to a disparity value of a reference pixel area. The target pixel area may refer to a random pixel area sequentially selected from among the plurality of pixel areas, and the reference pixel area may refer to a pixel area disposed in the center of the pixel array 140 among the plurality of pixel areas.

The post-processor 240 may generate the depth map DMAP on the basis of the plurality of calibrated disparity values CDPs. For example, the post-processor 240 may include a color map converter.

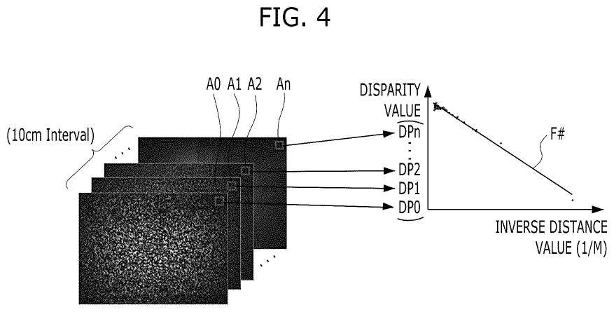

Hereinafter, an operation of the image processing system 10 in accordance with an embodiment of the present disclosure, which has the above-described configuration, is described with reference to FIGS. 4 to 6.

First, an operation of the image processing system 10 during the test mode is described.

The image sensor 100 may capture a scene having the same texture pattern (e.g., flat pattern) for each distance M while a focus point is fixed. For example, the image sensor 100 may capture the same scene multiple times at “10 cm” intervals. The image sensor 100 may generate the pixel values IMGs corresponding to the plurality of captured images.

The image processor 200 may estimate the linear functions corresponding to the plurality of pixel areas from the plurality of images on the basis of the pixel values IMGs. For example, the image processor 200 may estimate each of the linear functions on the basis of the inverse distance value 1/M and the disparity value for each pixel area. Each of the linear functions may be estimated through the least square method.

FIG. 4 shows an example of estimating a random linear function F # among the plurality of linear functions.

Referring to FIG. 4, the image processor 200 may calculate disparity values DP0, DP1, DP2, . . . , and DPn respectively corresponding to pixel areas A0, A1, A2, . . . , and An at the same position from the plurality of images, and represent a relationship between the calculated disparity values DP0, DP1, DP2, . . . , and DPn and the inverse distance values 1/M by line fitting. The line fitting may refer to the linear function F #, and be estimated through the least square method.

Although the process of estimating only one linear function F # is described as an example, the process may be applied to the present embodiment in the same manner, and the plurality of linear functions corresponding to the plurality of pixel areas may be all estimated and used.

The image processor 200 may generate the calibration map CMAP according to the linear functions. For example, the calibration map CMAP may include the first characteristic map corresponding to the slopes of the linear functions representing the characteristics of the plurality of pixel areas and the second characteristic map corresponding to the intercepts, i.e., y-intercepts, of the linear functions.

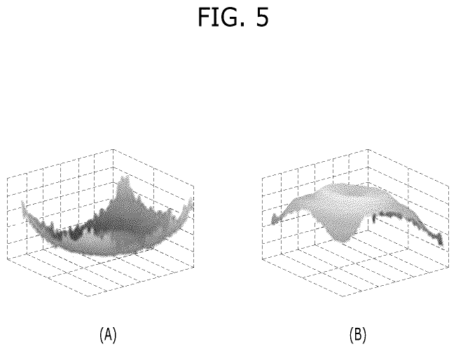

FIG. 5 shows an example of the first characteristic map and the second characteristic map.

Referring to (A) of FIG. 5, the first characteristic map may represent the slopes of the linear functions, among characteristics of the plurality of images, in correspondence to positions of the plurality of pixel areas.

Referring to (B) of FIG. 5, the second characteristic map may represent the intercepts, i.e., y-intercepts, of the linear functions, among the characteristics of the plurality of images, in correspondence to the positions of the plurality of pixel areas.

In an embodiment, the image processor 200 may sample the first reference calibration map corresponding to low luminance on the basis of the pixel values IMGs inputted according to the low luminance, and sample the second reference calibration map corresponding to high luminance on the basis of the pixel values IMGs inputted according to the high luminance. The image processor 200 may generate at least one third reference calibration map by interpolating the first and second reference calibration maps. The image processor 200 may select and use one of the first to third reference calibration maps as the calibration map CMAP.

Next, an operation of the image processing system 10 during the normal mode is described.

The image sensor 100 may capture the current scene, and generate the pixel values IMGs corresponding to the captured image.

The image processor 200 may generate the depth map DMAP on the basis of the pixel values IMGs. For example, the image processor 200 may generate the depth map DMAP by mapping a disparity value of a target pixel area among the plurality of pixel areas to a disparity value of a reference pixel area among the plurality of pixel areas. The target pixel area may refer to a random pixel area sequentially selected from among the plurality of pixel areas, and the reference pixel area may refer to a pixel area disposed in the center of the pixel array 140 among the plurality of pixel areas.

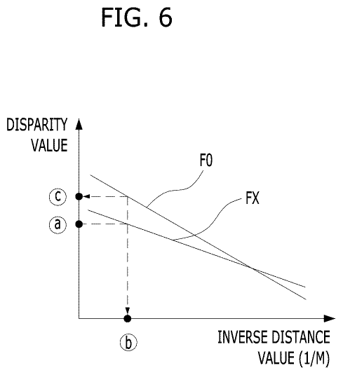

FIG. 6 shows a graph for describing a process of mapping the disparity value of the target pixel area to the disparity value of the reference pixel area.

Referring to FIG. 6, the image processor 200 may back-track an inverse distance value \textcircled{b} corresponding to a disparity value \textcircled{a} of the target pixel area according to a linear function Fx corresponding to the position of the target pixel area, on the basis of the calibration map CMAP, and then track a disparity value \textcircled{c} of the reference pixel area corresponding to the inverse distance value \textcircled{b} according to a linear function FO corresponding to the position of the reference pixel area. This process may be expressed as in “Equation 1” below.

D′(X)=Iz(0)+Sz(0)(D(X)−Iz(x))/Sz(X) [Equation 1]

Herein, “X” may refer to the position of the target pixel area, “0” may refer to the position of the reference pixel area, “D′(X)” may refer to the disparity value \textcircled{c} of the reference pixel area, i.e., a calibrated disparity value, “D(X)” may refer to the disparity value \textcircled{a} of the target pixel area, i.e., an un-calibrated disparity value, “Iz(0)” may refer to an intercept of the reference pixel area, “Sz(0)” may refer to a slope of the reference pixel area, “Iz(X)” may refer to an intercept of the target pixel area, and “Sz(X)” may refer to a slope of the target pixel area.

In an embodiment, the image processor 200 may selectively use the calibration map CMAP suitable for current illuminance.

According to an embodiment of the present disclosure, by calibrating a disparity value, it is possible to evenly reflect a blurring phenomenon in a background part of an image and use a calibration map suitable for current illuminance.

According to an embodiment of the present disclosure, by evenly reflecting a blurring phenomenon in a background part of an image, it is possible to improve uniformity of the background part.

In addition, according to an embodiment of the present disclosure, by using an appropriate calibration map according to illuminance, it is possible to properly calibrate a depth map regardless of the illuminance.

While the present disclosure has been illustrated and described with respect to specific embodiment, the disclosed embodiment is provided for the description, and not intended to be restrictive. Further, it is noted that the present disclosure may be achieved in various ways through substitution, change, and modification that fall within the scope of the following claims, as those skilled in the art will recognize in light of the present disclosure. Furthermore, the embodiments may be combined to form additional embodiments.

What is claimed is:

1. An image processor comprising:
a calibration map generator configured to generate a calibration map representing characteristics of pixel values corresponding to a depth map; and
a calibrator configured to calibrate a disparity value for each pixel area based on the pixel values and the calibration map.

2. The image processor of claim 1, wherein the calibration map includes:
a first characteristic map corresponding to slopes of linear functions representing characteristics of a plurality of pixel areas, and
a second characteristic map corresponding to intercepts of the linear functions.

3. The image processor of claim 2, wherein each of the linear functions represents a relationship between a disparity value and an inverse distance value, which are generated for each pixel area.

4. The image processor of claim 1, wherein the calibration map and the depth map have a same resolution.

5. The image processor of claim 1, wherein the calibrator is configured to map a disparity value of a target pixel area among a plurality of pixel areas to a disparity value of a reference pixel area among the plurality of pixel areas.

6. The image processor of claim 5, wherein the reference pixel area includes a pixel area disposed in a center of a pixel array, among the plurality of pixel areas included in the pixel array.

7. The image processor of claim 1, wherein the calibration map generator is configured to generate at least two reference calibration maps according to illuminance, and use, as the calibration map, a reference calibration map corresponding to current illuminance, among the at least two reference calibration maps.

8. The image processor of claim 1, wherein the calibration map generator is configured to sample at least two first reference calibration maps according to illuminance, generate at least one second reference calibration map by interpolating the at least two first reference calibration maps, and use, as the calibration map, a reference calibration map corresponding to current illuminance between the at least two first reference calibration maps and the at least one second reference calibration map.

9. An image processing system comprising:
an image sensor including a plurality of pixel areas, and configured to generate pixel values from the plurality of pixel areas; and
an image processor configured to, based on the pixel values and a calibration map, calibrate a disparity value for each pixel area, and generate a depth map.

10. The image processing system of claim 9, wherein the image processor is configured to generate the depth map by mapping a disparity value of a target pixel area among the plurality of pixel areas to a disparity value of a reference pixel area among the plurality of pixel areas.

11. The image processing system of claim 10, wherein the reference pixel area includes a pixel area disposed in a center of a pixel array, among the plurality of pixel areas included in the pixel array.

12. The image processing system of claim 9, wherein the calibration map includes:
a first characteristic map corresponding to slopes of linear functions representing characteristics of the plurality of pixel areas, and
a second characteristic map corresponding to intercepts of the linear functions.

13. The image processing system of claim 12, wherein each of the linear functions represents a relationship between a disparity value and an inverse distance value, which are generated for each pixel area.

14. The image processing system of claim 9, wherein the calibration map and the depth map have a same resolution.

15. The image processing system of claim 9, wherein the image processor includes:
a pre-processor configured to generate a plurality of disparity values corresponding to the plurality of pixel areas based on the pixel values;
a calibration map generator configured to generate the calibration map;
a calibrator configured to map a disparity value of a target pixel area among the plurality of pixel areas to a disparity value of a reference pixel area among the plurality of pixel areas, based on the plurality of disparity values and the calibration map; and
a post-processor configured to generate the depth map based on the disparity values generated by the calibrator.

16. The image processing system of claim 15, wherein the calibration map generator is configured to generate at least two reference calibration maps according to illuminance, and use, as the calibration map, a reference calibration map corresponding to current illuminance, among the at least two reference calibration maps.

17. The image processing system of claim 15, wherein the calibration map generator is configured to sample at least two first reference calibration maps according to illuminance, generate at least one second reference calibration map by interpolating the at least two first reference calibration maps, and use, as the calibration map, a reference calibration map corresponding to current illuminance between the at least two first reference calibration maps and the at least one second reference calibration map.

18. An image processing method comprising:
generating, based on pixel values generated from a plurality of pixel areas of an image sensor, a plurality of disparity values corresponding to the plurality of pixel areas;
generating a calibration map representing characteristics of the pixel values;
mapping, based on a plurality of disparity values and the calibration map, a disparity value of a target pixel area among the plurality of pixel areas to a disparity value of a reference pixel area among the plurality of pixel areas,
generating a depth map based on the disparity values.

19. The image processing method of claim 18, wherein the generating of the calibration map includes:
generating at least two reference calibration maps according to illuminance; and
using, as the calibration map, a reference calibration map corresponding to current illuminance, among the at least two reference calibration maps.

20. The image processing method of claim 18, wherein the generating of the calibration map includes:
sampling at least two first reference calibration maps according to illuminance;
generating at least one second reference calibration map by interpolating the at least two first reference calibration maps; and
using, as the calibration map, a reference calibration map corresponding to current illuminance between the at least two first reference calibration maps and the at least one second reference calibration map.
